(19) United States
(12) Patent Application Publication
(10) Pub. No.: US 2011/0089187 A1
(43) Pub. Date: Apr. 21, 2011

(54) Shatterproof Container And Cap Assembly

(75) Inventors: Jeffrey H. Steiger, Auburn, AL (US); James J. Lessley, Auburn, AL (US); Randall C. Lecroy, Opelika, AL (US); Michael Lee Pillen, Auburn, AL (US)

(73) Assignee: CAPITOL VIAL INC., Auburn, AL (US)

(21) Appl. No.: 12/909,409

(22) Filed: Oct. 21, 2010

Related U.S. Application Data
(63) Continuation-in-part of application No. 11/463,721, filed on Aug. 10, 2006.

(51) Int. Cl. B65D 43/14; B29C 45/00

(52) U.S. Cl. 220/839; 264/299

(57) ABSTRACT

A shatterproof container and cap assembly includes a container body defining a cavity and being formed from polypropylene impact copolymer, and a cap integrally connected to the container body. A single annular recess is formed in a lip at an open end of the container body. The cap includes first and second sealing flanges that form a generally fluid tight seal with the open end of the container body.

### CROSS-REFERENCE TO RELATED APPLICATIONS

This application is a continuation-in-part of co-pending U.S. patent application Ser. No. 11/463,721, filed Aug. 10, 2006, the entire disclosure of which is hereby expressly incorporated by reference herein in its entirety.

### FIELD OF THE INVENTION

The present invention relates generally to containers and, more particularly, to a sealable container for use in transporting liquid samples or specimens in the container.

### BACKGROUND OF THE INVENTION

In the past, sealable containers, such as vials, have been used to collect, store and/or dispense liquids, such as a test sample of milk, urine, saliva or blood by way of example. The liquid sample may be collected in the vial at one site and then the vial is transported to another site where the liquid sample is removed from the vial and subjected to diagnostic testing.

Vials of the type to which the present invention relates are generally injection molded plastic vials that have caps adapted to seal the vial closed with a substantially fluid-tight seal. The cap may or may not be integrally connected to the vial, but oftentimes it is connected thereto by a flexible strap or tab.

During transportation of the vial and the liquid sample contained therein from the collection site to the test site, the vials are susceptible to breakage due to excessive crushing forces being applied to the vials. In the event that a vial breaks due to the excessive forces, the liquid sample may leak or spill from the vial. In some cases, the vials are also exposed to a high negative air pressure, such as that experienced in the cargo portion of an airplane.

One approach to address the possibility of breakage is to transport the vials containing the liquid samples inside bags or boxes such that, if a vial breaks, the liquid sample will be contained within a controlled volume (i.e., the volume defined by the outer bag or box). A drawback with this approach is that the provision of outer containers such as bags or boxes adds complexity and cost to the transportation operation. Yet another drawback is that, upon breakage of a vial, the sharp edges of the broken vial material (e.g., glass, hard plastic, or the like) may puncture the outer container, thereby permitting the liquid sample to leak from the outer container.

Accordingly, there is a need for an improved container and cap assembly that provides a reliable fluid-tight seal to contain a liquid sample within the container, and which addresses these and other drawbacks of conventional containers.

### SUMMARY OF THE INVENTION

The present invention overcomes the foregoing and other shortcomings and drawbacks of containers heretofore known having a cap for sealing an open end of the container. While the invention will be described in connection with certain embodiments, it will be understood that the invention is not limited to these embodiments. To the contrary, the invention includes all alternatives, modifications and equivalents as may be included within the spirit and scope of the present invention.

In accordance with an embodiment of the present invention, a container and cap assembly is provided having a container body, such as a vial, and a cap configured to seal the container body in a generally fluid-type manner. The container body defines a cavity and has a closed end and an open end. A cap is integrally connected to the container body and has a top wall and an annular skirt wall depending from the top wall. In a specific embodiment, the container body has an annular lip at the open end and the assembly includes an annular first sealing flange that depends from the top wall of the cap and which is disposed radially inwardly from the skirt wall of the cap.

The first sealing flange is configured to be received within the recess formed in the lip of the container body when the cap is closed over the open end and generally form a seal with the inner lip. In that specific embodiment, moreover, an annular second sealing flange depends from the top wall of the cap and is disposed radially inwardly from the first sealing flange. The second sealing flange is configured to be received within the container body adjacent the inner lip and generally form a seal with an inner surface of the inner lip when the cap is closed over the open end.

In one embodiment, the container body is formed from a plastic material having a notched Izod impact strength value, at 23° C., of at least about 101 Joules/meter (1.9 ft-lbf/inch), In one embodiment, a suitable plastic material is used having a notched Izod impact strength value, at 23° C., of about 117 Joules/meter (2.2 ft-lbf/in). Additionally or alternatively, the plastic material may have a secant flexural modulus of at least about 1158 MPa (168,000 psi) and/or a tangent flexural modulus of at least about 1296 MPa (188,000 psi). In another embodiment, the container body is formed from a polypropylene impact copolymer.

The sample container and cap assembly of the present invention is intended to provide leak-proof and shatterproof characteristics at relatively high levels of negative pressure surrounding the assembly, so that liquid samples contained within the sample container may be transported by air without the need for outer containers typically used to address the possibility of leakage or spills of liquid sample material from the interior of the sample containers.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is perspective view of a container and cap assembly according to one embodiment of the present invention, showing the cap removed from the open top of the container;

FIG. 2 is top plan view of the container and cap assembly shown in FIG. 1;

FIG. 3 is a cross-sectional view taken along line 3-3 of FIG. 2;

FIG. 4 is an enlarged view of the encircled portion 4 shown in FIG. 3;

FIG. 5 is an enlarged view of the encircled portion 5 shown in FIG. 3;

FIG. 6 is a cross-sectional view of the container and cap assembly of FIG. 1, showing the cap closed over the open top of the container; and

FIG. 7 is an enlarged view of the encircled area 7 shown in FIG. 6.

### DETAILED DESCRIPTION OF THE PREFERRED EMBODIMENT

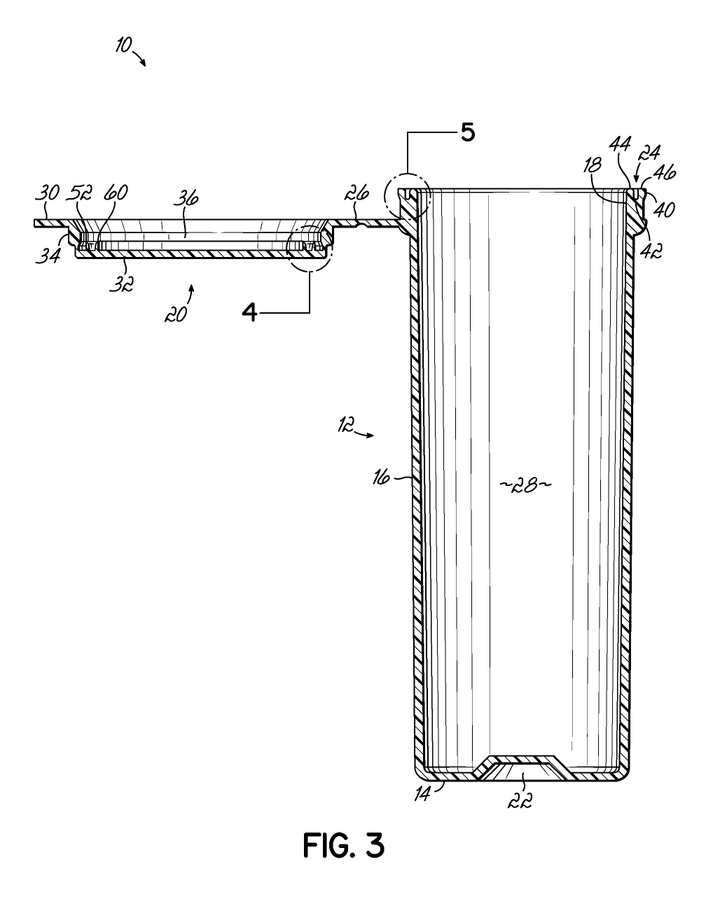

Referring now to the figures, a container and cap assembly 10 is shown in accordance with one embodiment of the present invention for collecting, storing, dispensing and/or transporting a liquid, such as a test sample of milk, urine, saliva or blood by way of example. The assembly 10 includes a container body 12, such as a vial, having a closed end 14, a generally tubular side wall 16 extending from the closed end 14 to an open end 18, and a cap 20 configured to close over the open end 18 to seal the container body 12 in a generally fluid-tight manner. The closed end 14 of the container body 12 may include a recessed central area 22 as shown in FIG. 3. As will be described in greater detail below, the cap 20 is configured to form a generally fluid-tight seal with an annular lip 24 provided at the open end 18 of the container body 12 when the cap 20 is closed over the open end 18.

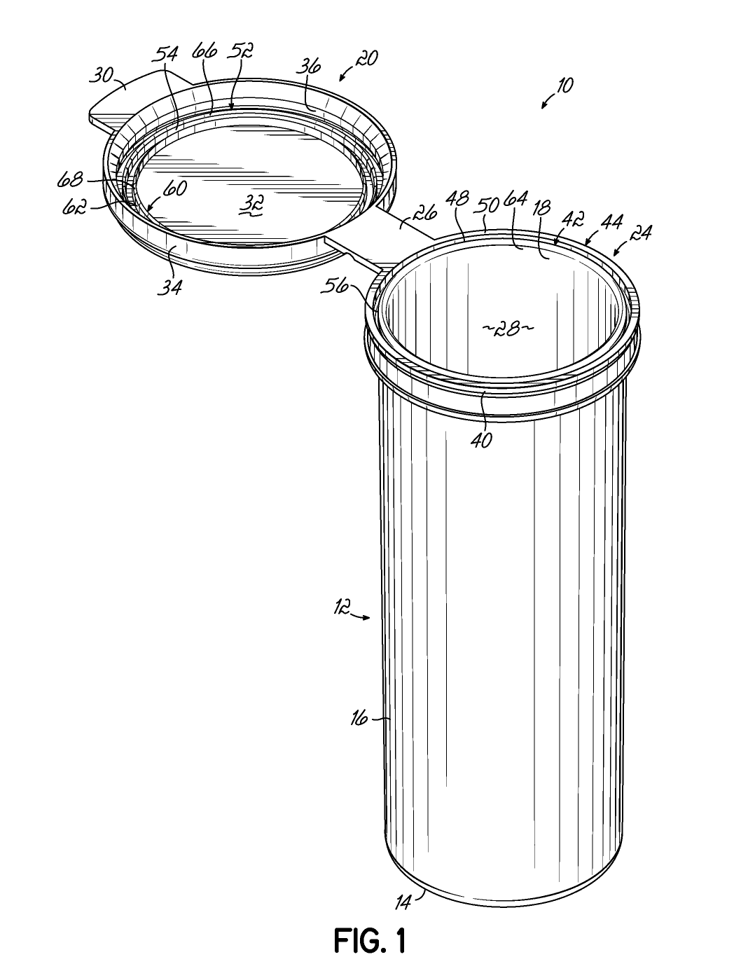

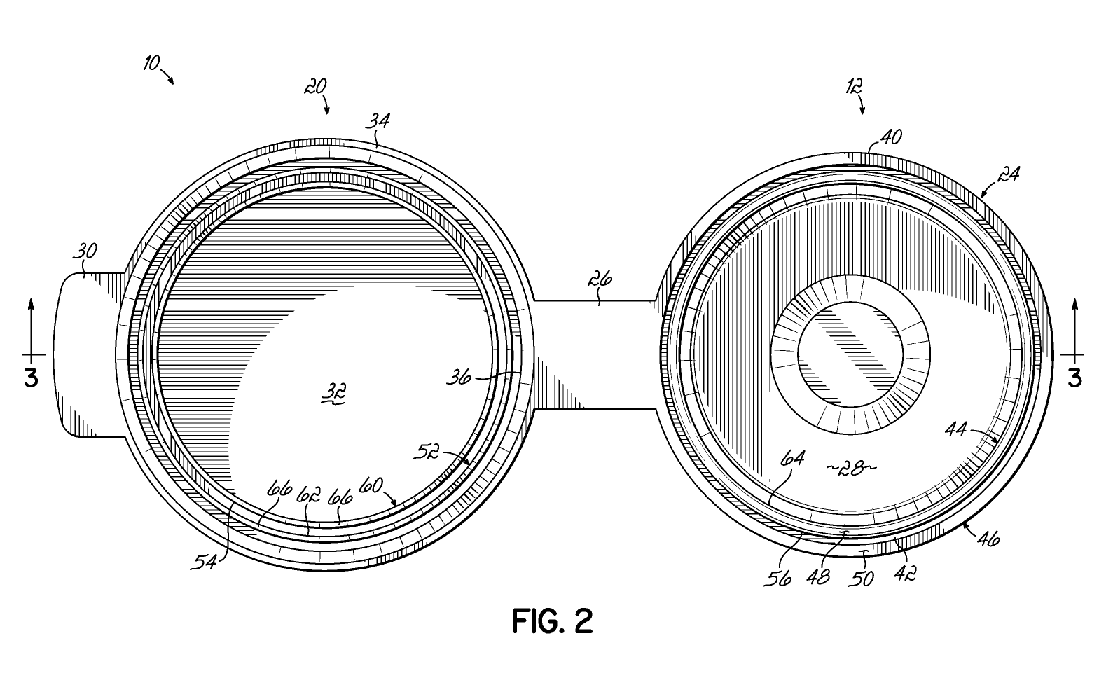

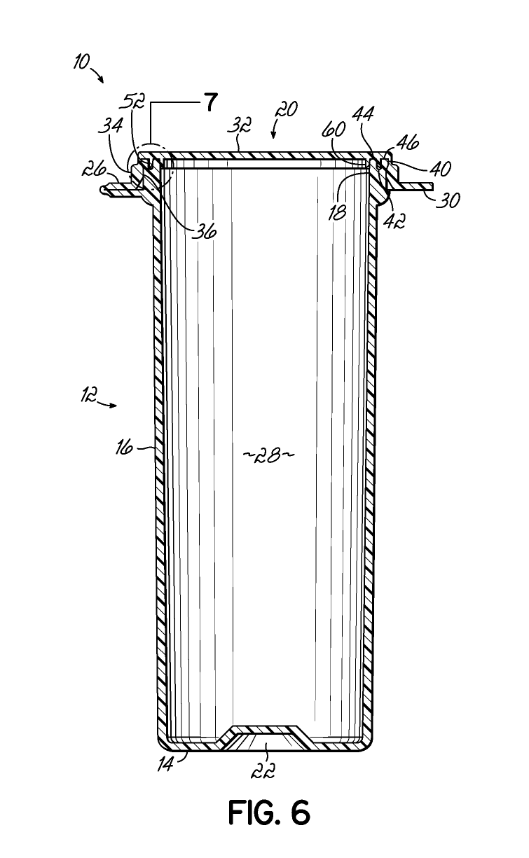

In one embodiment, the assembly 10 may be made of a one-piece injection molded thermoplastic construction with the cap 20 formed integrally with the container body 12 during a molding operation and connected thereto by a flexible strap or tab 26. The strap or tab 26 allows the cap 20 to move between an open position as shown in FIGS. 1-3, wherein a storage volume or cavity 28 within the container body 12 is accessible through the open end 18, and a closed position as shown in FIGS. 6 and 7, in which the cap 20 forms a generally fluid-tight seal with the annular lip 24. A tab 30 (FIGS. 1-3 and 6) may be provided extending outwardly from the cap 20 to facilitate opening and closing of the cap 20 by hand during use of the container and cap assembly 10.

The container body 12 and the cap 20 of assembly 10 may be made of polypropylene, polyethylene, polystyrene or any other suitable material. In a specific embodiment, the container body 12 is formed from a suitably chosen shatterproof material so that the container assembly 10 can sustain high handling forces and vacuum forces typical of air transportation, without permitting breakage of container body 12, while maintaining a fluid-tight seal between the container body 12 and the cap 20. An exemplary material suitable for forming the container body 12 is a polypropylene impact copolymer, such as a material identified under the designation Marlex® PP ALN-230, antistatic, and commercially available from the Phillips Sumika Polypropylene Company of The Woodlands, Texas.

The exemplary material identified above has as the main components thereof propylene ethylene copolymer and polypropylene, according to Material Safety Data Sheet (“MSDS”) No. 240590, revised Dec. 4, 2008, and available from the Phillips Sumika Polypropylene Company. Table 1, below, identifies some of the ASTM nominal properties for that exemplary material, with the data therein being available also from the above-cited MSDS, and with that data having a revision date of July 2007.

TABLE 1
ASTM NOMINAL PROPERTIES

| | English | | SI | | |
|---|---|---|---|---|---|
| Property | units | | units | | Method |
| Density | 0.9 | g/cc | 0.9 | g/cc | ASTM D1505 |
| Melt Flow Rate, @230° C. | 20 g/10 min | | 20 g/10 min | | ASTM D1238 |
| Tensile Strength at Yield, 50 mm/min | 3,600 | psi | 24.8 | MPa | ASTM D638 |
| Flexural Modulus, Tangent, 13 mm/min | 195,000 | psi | 1,340 | MPa | ASTM D790 |
| Flexural Modulus, Secant, 1.3 mm/min | 175,000 | psi | 1,200 | MPa | ASTM D790 |
| Notched Izod Impact Strength, @ 23° C. | 2.2 | ft-lbf/in | 117 | J/m | ASTM D256 |
| Notched Izod Impact Strength, @ 0° C. | 1 | ft-lbf/in | 53 | J/m | ASTM D256 |
| Notched Izod Impact Strength, @ −30° C. | 0.7 | ft-lbf/in | 37 | J/m | ASTM D256 |
| Heat Deflection Temperature, @ 0.455 MPa | 225° | F. | 107° | C. | ASTM D648 |
| Heat Deflection Temperature, @ 1.82 MPa | 132° | F. | 56° | C. | ASTM D648 |

| | | | |
|---|---|---|---|
| Rockwell Hardness, R Scale | 91 | 91 | ASTM D785 |
| Shore D Hardness | 60 | 60 | ASTM D2240 |

As used in the above table, the various ASTM methods refer to methods available as of the date of availability of the data contained in the table (i.e., July 2007). The description of each of these ASTM methods is hereby expressly incorporated herein by reference in its entirety. In one embodiment, the cap 20 includes a top wall 32 and a skirt wall 34 depending from the top wall 32. An inner surface 36 of the skirt wall 34 is provided with a contour (see FIG. 7) that is configured to generally form a seal with a contoured outer surface 40 provided on the annular lip 24 when the cap 20 is closed as shown in FIGS. 6 and 7.

While the embodiment described herein uses the material described above in Table 1, those of ordinary skill in the art will readily appreciate that the same is intended to be an example and is therefore not intended to be limiting, insofar as other materials having similar properties to those listed in Table 1 may be used instead.

For example, it is contemplated that other plastic materials may be used having a notched Izod impact strength, at 23° C., of at least about 101 Joules/meter (1.9 ft-lbf/in), and/or a secant flexural modulus of at least about 1158 MPa (168,000 psi) and/or a tangent flexural modulus of at least about 1296 MPa (188,000 psi), and/or a melt flow rate at 230° C. in the range of about 11 to about 23 g/cc, without departing from the spirit and scope of present invention.

An annular recess 42 (FIGS. 1 and 5) may be provided in the annular lip 24 to define an annular inner lip 44 and an annular outer lip 46. The inner lip 44 is spaced from the outer lip 46 by the recess 42. The inner lip 44 may include an upper surface 48 having a radiused cross-sectional profile while the outer lip 46 may include an upper surface 50 having a generally planar cross-sectional profile as shown in FIG. 5. In one embodiment, the cap 20 generally forms a seal with the upper surfaces 48 and 50 of the inner and outer lips 44 and 46, respectively, when the cap 20 is closed. It should be understood that other configurations and cross-sectional profiles of the inner and outer lips 44 and 46 are possible as well.

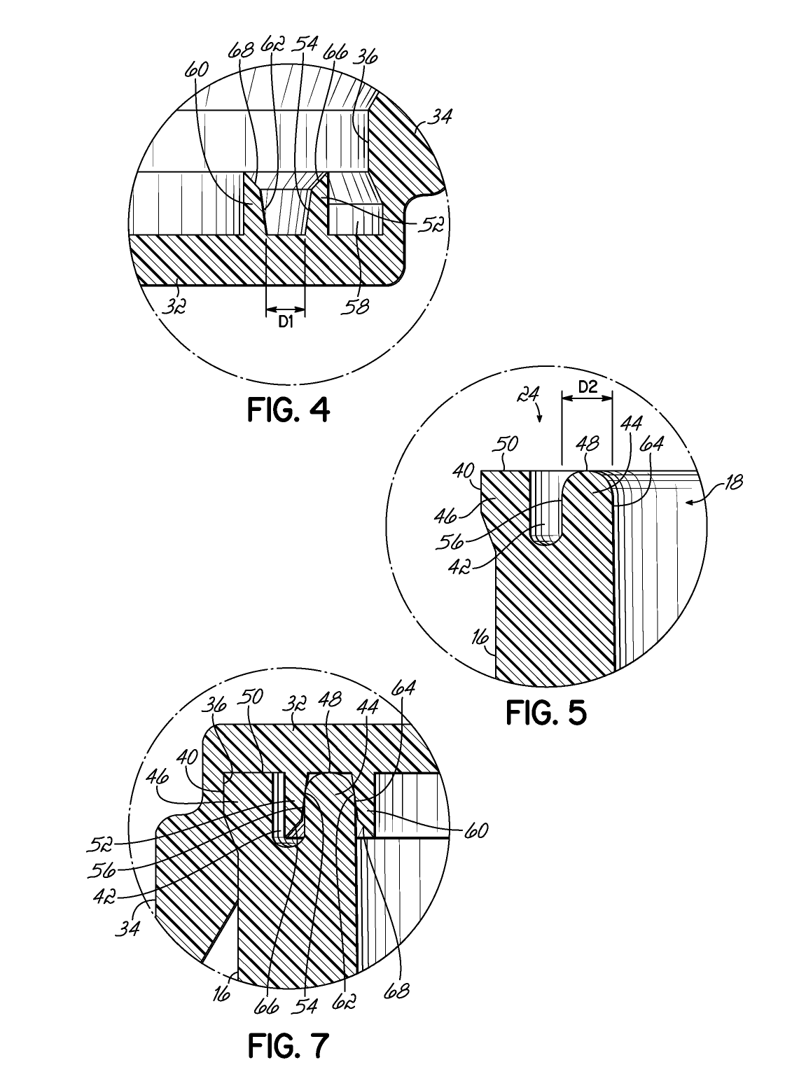

The cap 20 may include a first annular sealing flange 52 that depends from the top wall 32 and is located radially inwardly from the skirt wall 34. The first sealing flange 52 is configured to be received in the recess 42 when the cap 20 is closed and has an inner surface 54 that generally forms a seal with an outer surface 56 of the inner lip 44. An annular gap 58 (FIG. 4) is formed between the first sealing flange 52 and the skirt wall 34 that is configured to receive the outer lip 44 of the container body 12 therein when the cap 20 is closed as shown in FIGS. 6 and 7.

The cap 20 may also include a second annular sealing flange 60 that depends from the top wall 32 and is located radially inwardly from the first sealing flange 52. The second sealing flange 60 is configured to be received within the container body 12 adjacent the inner lip 44. When the cap 20 is closed as shown in FIG. 7, the second sealing flange 60 has an outer surface 62 that generally forms a seal with an inner surface 64 of the inner lip 44.

As shown in FIGS. 4 and 7, the inner surface 54 of the first sealing flange 52 confronts the outer surface 62 of the second sealing flange 60 (FIGS. 4 and 7). Proximate the junctures of the first and second sealing flanges 52 and 60 with the cap 20, the confronting surfaces 54 and 62 of the sealing flanges 52 and 60, respectively, may be spaced apart a distance “D1” (FIG. 4) that is slightly less than a cross-sectional thickness “D2” (FIG. 5) of inner lip 44. The first and second sealing flanges 52 and 60 may be generally flexible so that as the inner lip 44 is received between the first and second sealing flanges 52 and 60 as the cap 20 is closed, the first and second sealing flanges 52 and 60 deflect away from each other as shown in FIG. 7. In this way, multiple sealing engagements are provided between the cap 20 and the annular lip 24 when the cap 20 is closed. These multiple sealing engagements include: 1) the outer surface 62 of the second sealing flange 60 and the inner surface 64 of the inner lip 44, 2) the upper surface 48 of the inner lip 44 and the cap 20, 3) the inner surface 54 of the first sealing flange 52 and the outer surface 56 of the inner lip 44, 4) the upper surface 50 of the outer lip 46 and the cap 20, and 5) the inner surface 36 of the skirt wall 34 and the outer surface 40 of the annular lip 24.

In one embodiment, as shown in FIGS. 4 and 7, each of the first and second sealing flanges 52 and 60 is provided at its free end with a chamfered surface 66 and 68, respectively. Each of the chamfered surfaces 66 and 68 confronts the inner lip 44 and cooperates with the radiused upper surface 48 of the inner lip 44 to facilitate closing of the cap 20 over the open end 18 when the inner lip 44 is received between the first and second sealing flanges 52 and 60. The first and second sealing flanges 52 and 60 may have generally the same height, although it will be appreciated that other configurations of the first and second sealing flanges 52 and 60 are possible as well.

The container and cap assembly 10 may be molded according to the processes fully disclosed in U.S. Pat. Nos. 4,783,056, 4,812,116, 6,303,064 and RE 37,676 (a reissue of U.S. Pat. No. 5,723,085), all owned by the common assignee and each disclosure of which is hereby incorporated by reference herein in its entirety. For example, in one embodiment, the container body 12 and the integral cap 20 may be injection molded of molten plastic material and the cap 20 may be closed over the open end 18 of the container body 12 before the molten plastic material has fully set. In this way, the cap 20 and container body 12 are allowed to cure and shrink together over a period of time while the cap 20 is closed so that the “fit” of the multiple engagement surfaces providing the various seals occurs after molding while the cap 20 and container body 18 cure and shrink together. The cap 20 may be closed while the container and cap assembly 10 is still in the mold. The heat from the molding process may be used to maintain sterility as the cap is closed so that the container and cap assembly 10 is “sterile-by-process.”

The container and cap assembly 10 of the present invention is intended to provide leak-proof characteristics at higher levels of internal pressure so that liquid samples contained within the container and cap assembly 10 may be transported by air. Specifically, the container and cap assembly 10 may be able to sustain, without leakage, an internal pressure that produces a pressure differential of at least 95 kPa in a temperature range of 40° C. to 55° C., thus complying with Packaging Instructions 602 of the IATA Dangerous Good Regulations issued by the International Air Transport Association. In addition, the container and cap assembly 10, when closed, is designed to provide leak-proof characteristics, without breaking, even if dropped, for example, from a height of about 5.5 feet (1.68 m). Further, the container and cap assembly 10 has shatterproof characteristics by virtue of the use of a plastic material having a notched Izod impact strength of at least about 101 Joules/meter.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of Applicants' general inventive concept.

Having described the invention,

We claim:

1. A shatterproof container and cap assembly, comprising:
a container body defining a cavity and having a closed and an open end; and
a cap integrally connected to the container body and having a top wall and an annular skirt wall depending from the top wall,
wherein the container body is formed from a plastic material having a notched Izod impact strength value, at 23° C., of at least about 101 Joules/meter.

2. The assembly of claim 1, wherein the container body is formed from a plastic material having a secant flexural modulus of at least 1158 MPa.

3. The assembly of claim 1, wherein the container body is formed from a plastic material having a tangent flexural modulus of at least 1296 MPa.

4. The assembly of claim 1, where in the container body has an annular lip at the open end, the assembly further comprising:
a single annular recess formed in the annular lip of the container body, the recess defining an annular inner lip and an annular outer lip at the open end;
an annular first sealing flange depending from the top wall of the cap and being disposed radially inwardly from the skirt wall of the cap, the first sealing flange being configured to be received within the recess formed in the lip of the container body when the cap is closed over the open end; and
an annular second sealing flange depending from the top wall of the cap and being disposed radially inwardly from the first sealing flange, the second sealing flange being configured to be received within the cavity defined by the container body adjacent the inner lip and generally form a seal with an inner surface of the inner lip when the cap is closed over the open end.

5. A shatterproof container and cap assembly, comprising:
a container body defining a cavity and being formed from a polypropylene impact copolymer, the container body having a closed end, an open end and an annular lip at the open end;
a single annular recess formed in the lip of the container body, the recess defining an annular inner lip and an annular outer lip at the open end;
a cap integrally connected to the container body and having a top wall and an annular skirt wall depending from the top wall;
an annular first sealing flange depending from the top wall of the cap and being disposed radially inwardly from the skirt wall of the cap, the first sealing flange being configured to be received within the recess formed in the lip of the container body when the cap is closed over the open end; and
an annular second sealing flange depending from the top wall of the cap and being disposed radially inwardly from the first sealing flange, the second sealing flange being configured to be received within the cavity defined by the container body adjacent the inner lip and generally form a seal with an inner surface of the inner lip when the cap is closed over the open end.

6. The assembly of claim 5, further comprising a flexible strap connecting the cap to the container body.

7. The assembly of claim 5, wherein the assembly is configured, when the cap is closed over the open end, to sustain a pressure differential of at least 95 kPa in a temperature range of 40° C. to 55° C. without leakage of a liquid contained within the container body.

8. The assembly of claim 5, wherein the assembly is configured, when the cap is closed over the open end, and a liquid is contained within the cavity of the container body, to sustain a drop of at least about 1.7 meters (5.5 ft.) without the container body breaking and without leakage of the liquid.

9. A shatterproof container and cap assembly, comprising:
a container body defining a cavity and being formed from a polypropylene impact copolymer, the container body having a closed end and an open end; and
a cap integrally connected to the container body and being configured to generally form a seal with the open end of the container body when the cap is closed over the open end;
wherein the assembly is configured, when the cap is closed over the open end, to sustain a pressure differential of at least 95 kPa in a temperature range of 40° C. to 55° C. without leakage of a liquid contained in the cavity of the container body.

10. The assembly of claim 9, further comprising a flexible strap connecting the cap to the container body.

11. The assembly of claim 9, wherein the assembly is configured, when the cap is closed over the open end, and a liquid is contained within the cavity of the container body, to sustain a drop of at least about 1.7 meters (5.5 ft.) without the container body breaking and without leakage of the liquid.

12. A shatterproof container and cap assembly, comprising:
a container body defining a cavity and being formed from a polypropylene impact copolymer, the container body having a closed end and an open end; and
a cap integrally connected to the container body and being configured to generally form a seal with the open end of the container body when the cap is closed over the open end;
wherein the assembly is configured, when the cap is closed over the open end, and a liquid is contained within the cavity of the container body, to sustain a drop of at least about 1.7 meters (5.5 ft.) without the container body breaking and without leakage of the liquid.

13. A method for forming a shatterproof container and cap assembly, comprising:
forming, in a mold, a container body from a polypropylene impact copolymer, the container body having a closed end, an open end, a cavity, an annular lip at the open end, and a single recess formed in the lip of the container body, the recess defining an annular inner lip and an annular outer lip at the open end;
molding a cap integrally connected to the container body, the cap having a top wall, an annular skirt wall depending from the top wall, an annular first sealing flange depending from the top wall of the cap and being disposed radially inwardly from the skirt wall of the cap, and an annular second sealing flange depending from the top wall of the cap and being disposed radially inwardly from the first sealing flange; and
closing the cap over the open end of the container body at the mold so that the first sealing flange is received within the recess formed in the lip of the container body and the second sealing flange is received within the cavity of the container body adjacent the inner lip to generally form a seal with an inner surface of the inner lip.

14. The method of claim 13, wherein the formed assembly is configured, when the cap is closed over the open end, to sustain a pressure differential of at least 95 kPa in a temperature range of 40° C. to 55° C. without leakage of a liquid contained within the container body.

15. The method of claim 13, wherein the formed assembly is configured, when the cap is closed over the open end, and a liquid is contained within the cavity of the container body, to sustain a drop of at least about 1.7 meters (5.5 ft.) without the container body breaking and without leakage of the liquid.
